(19) United States
(12) Patent Application Publication
(10) Pub. No.: US 2015/0239184 A1
(43) Pub. Date: Aug. 27, 2015

(54) SOLVENT ANNEALING OF BLOCK COPOLYMER FILMS UNDER SUPER-SATURATED ATMOSPHERES

(71) Applicants: University of Chicago, Chicago, IL (US); HGST Netherlands B.V., Amsterdam (NL)

(72) Inventors: Yves-Andre Chapuis, San Fransciso, CA (US); Ricardo Ruiz, Santa Clara, CA (US); Lei Wan, San Jose, CA (US); Paul F. Nealey, Chicago, IL (US); Shisheng Xiong, San Jose, CA (US)

(73) Assignees: University of Chicago, Chicago, IL (US); HGST Netherlands B.V., Amsterdam (NL)

(21) Appl. No.: 14/187,071

(22) Filed: Feb. 21, 2014

(51) Int. Cl. B29C 71/00; B29C 35/00

(52) U.S. Cl. CPC B29C 71/0009; B29C 35/00; B29K 2025/08

(57) ABSTRACT

In one embodiment, a system for solvent annealing of a block copolymer film includes a solvent annealing chamber, and a controller configured to control at least one processing parameter for inducing a super-saturation of a solvent in an atmosphere within the solvent annealing chamber. In another embodiment, a method for solvent annealing of a block copolymer film includes inducing a super-saturation of a solvent in an atmosphere within a solvent annealing chamber having a block copolymer film therein for inducing formation of polymeric domains.

### FIELD OF THE INVENTION

The present invention relates to block copolymer films and methods of making the same, and more particularly, this invention relates to the solvent annealing of block copolymer films under super-saturated atmospheres.

### BACKGROUND

Block copolymer patterns are useful and viable alternatives for sublithographic resolution patterning. Thin films of block copolymers self-assemble at dimensions in the range of 5-50 nm making them very attractive for lithographic applications. Block copolymers are polymeric chains with two or more incompatible/immiscible blocks joined by covalent bonds. By annealing the polymer above its glass transition temperature (T_{g}) the polymer chains gain enough mobility to diffuse. The strength of the incompatibility between the blocks will drive the system towards an equilibrium morphology which in many cases results in periodic, uniform patterns that can be useful for lithography. Stated another way, free energy minimization induces micro-phase separation of the incompatible, but bonded, blocks, resulting in periodic polymeric domains. Upon selective removal of one of the block materials from an assembled block copolymer thin film, the remaining portion of the film can act as a lithographic mask.

### SUMMARY

According to one embodiment, a system for solvent annealing of a block copolymer film includes a solvent annealing chamber, and a controller configured to control at least one processing parameter for inducing a super-saturation of a solvent in an atmosphere within the solvent annealing chamber.

According to another embodiment, a method for solvent annealing of a block copolymer film includes inducing a super-saturation of a solvent in an atmosphere within a solvent annealing chamber having a block copolymer film therein for inducing formation of polymeric domains.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a simplified drawing of a magnetic recording disk drive system.

FIG. 2A is a schematic representation of an A-B diblock copolymer, according to one embodiment.

FIG. 2B is a schematic representation of a block copolymer with spherical polymeric domains.

FIG. 2C is a schematic representation of a block copolymer with cylindrical polymeric domains.

FIG. 2D is a schematic representation of a block copolymer with lamellar polymeric domains.

FIG. 3A is a schematic representation of a system for solvent annealing a block copolymer film in a super-saturated atmosphere, according to one embodiment.

FIG. 3B is a schematic representation of a solvent annealing chamber including a piston volume control feature, according to one embodiment.

FIG. 4 is a flowchart of a method, according to one embodiment.

FIG. 5A is a top-view of a scanning electron microscope (SEM) image of a lamellae-forming poly(2 vinyl pyridine-b-styrene-b-2 vinyl pyridine) (P2VP-b-PS-b-P2VP) triblock copolymer film with a pitch of 16 nm formed using conventional solvent annealing under a saturated or near saturated atmosphere. The time period for this conventional solvent annealing process was 30 minutes.

FIG. 5B is a top-view SEM image of the lamellae-forming (P2VP-b-PS-b-P2VP) triblock copolymer film of FIG. 5A formed using (P2VP-b-PS-b-P2VP) triblock copolymer film formed using the same conventional solvent annealing process but over a time period of several hours.

FIG. 5C provides a close-up/zoomed in view of the SEM image shown in FIG. 5B and illustrates the dewetting of the lamellae-forming (P2VP-b-PS-b-P2VP) triblock copolymer film.

FIG. 6 is a top SEM image of the lamellae-forming (P2VP-b-PS-b-P2VP) triblock copolymer film with a pitch of 16 nm formed via solvent annealing in a super-saturated atmosphere. The time period for this super-saturated solvent annealing process was about 1 minute.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

it must also be noted that, as used in the specification and the appended claims, the singular forms “a,” “an” and “the” include plural referents unless otherwise specified.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm.

The following description discloses several preferred embodiments of Hock copolymer films and/or related systems and methods. According to one particular embodiment, a method and system is described for solvent annealing a block copolymer film under super-saturation of the solvent vapor such that the solvent vapor crosses the dew point. This controlled condensation causes a very high swelling ratio of the film over a sufficiently short period of time thereby avoiding dewetting of the film. Moreover, the additional swelling facilitates high mobility of the polymer blocks, resulting in fast, low-defectivity self-assembly. In further preferred embodiment, suitable solvents (e.g., neutral solvents) may be used to induce the self-assembly of a block copolymer with the microdomains oriented perpendicularly to the substrate (which may not be possible under thermal annealing). Various preferred embodiments may achieve this super-saturation condition (i.e., may cross the dew point) in a solvent annealing chamber having a block copolymer sample therein by: increasing the absolute molar content of solvent vapor while keeping temperature constant in the chamber; towering the chamber temperature, which in turn lowers the vapor pressure of the solvent vapor; and/or reducing the volume of the chamber while keeping the total number of moles constant.

In one general embodiment, a system for solvent annealing of a block copolymer film includes a solvent annealing chamber, and a controller configured to control at least one processing parameter for inducing a super-saturation of a solvent in an atmosphere within the solvent annealing chamber.

In another general embodiment, a method for solvent annealing of a block copolymer film includes inducing a super-saturation of a solvent in an atmosphere within a solvent annealing chamber having a block copolymer film therein for inducing formation of polymeric domains.

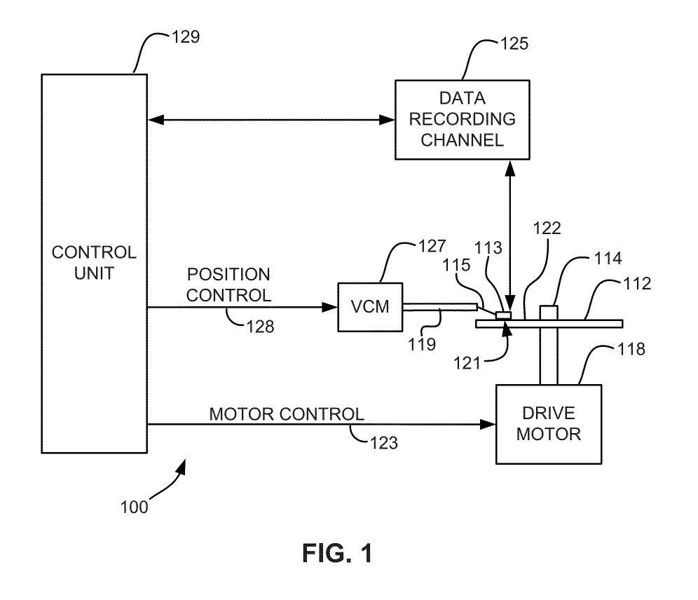

Referring now to FIG. 1, there is shown a disk drive 100 in accordance with one embodiment of the present invention. As shown in FIG. 1, at least one rotatable magnetic medium (e.g., magnetic disk) 112 is supported on a spindle 114 and rotated by a drive mechanism, which may include a disk drive motor 118. The magnetic recording on each disk is typically in the form of an annular pattern of concentric data tracks (not shown) on the disk 112. Thus, the disk drive motor 118 preferably passes the magnetic disk 112 over the magnetic read/write portions 121, described immediately below.

At least one slider 113 is positioned near the disk 112, each slider 113 supporting one or more magnetic read/write portions 121, e.g., of a magnetic head according to any of the approaches described and/or suggested herein. As the disk rotates, slider 113 is moved radially in and out over disk surface 122 so that portions 121 may access different tracks of the disk where desired data are recorded and/or to be written. Each slider 113 is attached to an actuator arm 119 by means of a suspension 115. The suspension 115 provides a slight spring force which biases slider 113 against the disk surface 122. Each actuator arm 119 is attached to an actuator 127. The actuator 127 as shown in FIG. 1 may be a voice coil motor (VCM). The VCM comprises a coil movable within a fixed magnetic field, the direction and speed of the coil movements being controlled by the motor current signals supplied by controller 129,

During operation of the disk storage system, the rotation of disk 112 generates an air bearing between slider 113 and disk surface 122 which exerts an upward force or lift on the slider. The air bearing thus counter-balances the slight spring force of suspension 115 and supports slider 113 off and slightly above the disk surface by a small, substantially constant spacing during normal operation. Note that in some embodiments, the slider 113 may slide along the disk surface 122.

The various components of the disk storage system are controlled in operation by control signals generated by controller 129, such as access control signals and internal clock signals. Typically, control unit 129 comprises logic control circuits, storage (e.g., memory), and a microprocessor. In a preferred approach, the control unit 129 is electrically coupled (e.g., via wire, cable, line, etc.) to the one or more magnetic read/write portions 121, for controlling operation thereof. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Read and write signals are communicated to and from read/write portions 121 by way of recording channel 125.

The above description of a typical magnetic disk storage system, and the accompanying illustration of FIG. 1 is for representation purposes only. It should be apparent that disk storage systems may contain a large number of disks and actuators, and each actuator may support a number of sliders.

An interface may also be provided for communication between the disk drive and a host (integral or external) to send and receive the data and for controlling the operation of the disk drive and communicating the status of the disk drive to the host, all as will be understood by those of skill in the art.

In a typical head, an inductive write portion includes a coil layer embedded in one or more insulation layers (insulation stack), the insulation stack being located between first and second pole piece layers. A gap is formed between the first and second pole piece layers of the write portion by a gap layer at or near a media facing side of the head (sometimes referred to as an ABS in a disk drive). The pole piece layers may be connected at a back gap. Currents are conducted through the coil layer, which produce magnetic fields in the pole pieces. The magnetic fields fringe across the gap at the media facing side for the purpose of writing bits of magnetic field information in tracks on moving media, such as in circular tracks on a rotating magnetic disk.

The second pole piece layer has a pole tip portion which extends from the media facing side to a flare point and a yoke portion which extends from the flare point to the back gap. The flare point is where the second pole piece begins to widen (flare) to form the yoke. The placement of the flare point directly affects the magnitude of the magnetic field produced to write information on the recording medium.

Conventional granular magnetic recording media may be limited by the superparamagnetic limit to densities on the order of about 1 Tb/in². One alternative to achieve thermally stable, writable media is by lithographically patterned media. There are two versions of patterned media: one is discrete track media (DTM) where the individual circumferential tracks are patterned and separated by grooves. A second form is bit patterned media (BPM) where individual bits are patterned and isolated by one another. Moreover, patterned magnetic recording media may include longitudinal magnetic recording disks, where the magnetization directions in the magnetizable recording material are parallel to or in the plane of the recording layer in the isolated bits, or perpendicular magnetic recording disks, where the magnetization directions are perpendicular to or out-of-the-plane of the recording layer in the isolated bits.

One method for fabricating patterned media (e.g., DTM and BPM) is via nanoimprint lithography, where a master mold may be used to replicate a lithographic mask by imprinting the mold pattern onto each disk. Accordingly, some embodiments described herein involve methods for fabricating nanostructures that may be used as lithographic tools to create DTM and/or BPM. In preferred approaches, these nanostructures may form and/or be part of an original master mold used for nanoimprint lithography. In various approaches, this muster mold may be used to create a stamper having a three dimensional topography that may in turn be used to nanoimprint masking material, e.g., photoresist, on magnetic recording disks. In other approaches, the nanostructures may be used to directly nanoimprint magnetic recording disks and/or used to make replica molds and/or stampers which are then used in processes to nanoimprint the disks.

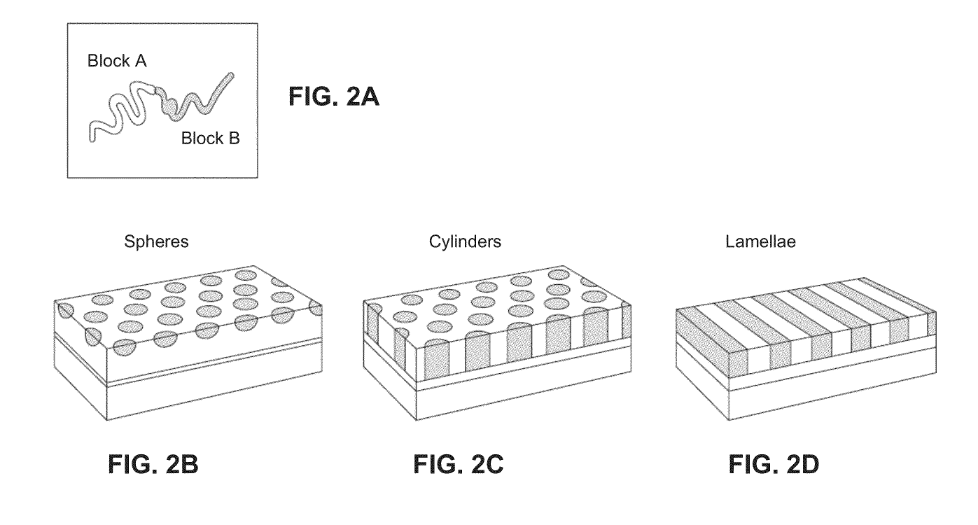

In some embodiments, self-assembled block copolymers may be used to create periodic nanometer (nm) scale features. A self-assembled block copolymer typically contains two or more different block copolymer components that are immiscible/incompatible with one another. A simplified representation of an A-B diblock copolymer is shown in FIG. 2A. In case of the symmetric A-B-A triblock copolymer with the same volume fraction, similar morphologies would form with pitch comparable to an A-B diblock having half of the molecular weight. Under suitable conditions, the two or more immiscible polymeric block components separate into two or more different phases or microdomains on a nanometer scale, thereby forming ordered patterns of isolated nano-sized structural units. Hone of the components is selectively removable without having to remove the other(s), then an orderly arranged structural units of the un-removed component(s) can be formed.

In several approaches, diblock copolymer films may form spherical, cylindrical, or lamellar polymeric domains. In preferred approaches, it is often desirable for lithographic applications to use cylindrical or la a domains oriented perpendicular to the substrate, FIGS. 2B-2D show illustrative examples of a block copolymer thin film with spherical (FIG. 2B), cylindrical (FIG. 2C) and lamellar (FIG. 2D) polymeric domains. Each of the block copolymer films shown in FIGS. 2B-2D may be made, for example by spin casting, coating, spraying, ink coating, dip coating, dip casting, etc. a polymer film from solution onto a substrate. Suitable solvents used to dissolve the block copolymer and form the block copolymer solution include, but are not limited to, toluene, propylene glycol monomethyl ether acetate (PGMEA), propyleneglycol monomethyl ether (PGME), acetone, or combinations thereof. Preferably, the block copolymer solution is applied (e.g., via spin casting or other suitable method) to the substrate surface to form a thin block copolymer layer, with a thickness less than 50 nm (0.2 L₀<thickness<3 L₀, where L₀ is the period of the block copolymer).

Examples of suitable block copolymers that may be used for forming self-assembled periodic patterns according to the embodiments described herein include but are not limited to poly(2 vinyl pyridine-b-styrene-b-2 vinyl pyridine) (P2VP-b-PS-b-P2VP), polystyrene-block-poly(methyl methacrylate) (PS-b-PMMA), polyisoprene-block-poly(ethylene oxide) (PI-b-PEO), polybutadiene-block-poly(ethylene oxide) (PBD-b-PEO), polystyrene-block-poly(ethylene oxide) (PS-b-PEO), poly(methyl methacrylate)-block-poly(ethylene oxide) (PMMA-b-PEO), poly(ethylene oxide)-block-polyethylethylene (PEO-b-PEE), polystyrene-block-poly(vinylpyridine) (PS-b-PVP), polystyrene-block-polyisoprene (PS-b-PI), polystyrene-block-polybutadiene (PS-b-PBD), polystyrene-block-poly(ferrocenyl dimethylsilane) (PS-b-PFS), polybutadiene-block-poly(vinylpyridine) (PBD-b-PVP), polyisoprene-block-poly(methyl methacrylate) (PI-b-PMMA), poly(styrene-block-lactic acid) (PS-b-PLA), polyhedral oligosilsesquioxane (POSS)-based hybrid polymers, poly(styrene-block-dimethylsilaxane) (PS-b-PDMS), etc. Additionally, suitable block copolymers that may be used for forming self-assembled periodic patterns according to the embodiments described herein are not limited to diblock copolymers, but may also include triblock copolymers, tetrablock copolymers, etc.

In some approaches, the substrate to which the block copolymer is applied may be previously modified and/or treated with a surface modification layer to promote a perpendicular orientation of the domains or for chemical pre-patterning for directed assembly. Examples of processes that utilize block copolymer directed self-assembly on topographically and/or chemically modified substrates for forming a master mold to be used for nanoimprinting high bit aspect ratio (BAR) patterned magnetic recording media are described in U.S. Pat. No. 8,119,017; U.S. Pat. No. 7,976,715; Chi-Chun Liu et al., Macromolecules, 44:1876-1885 (2011); and Lei Wan et al., J. Micro/Nanolith MEMS MOEMS, 11(3):031405-1-031405-5 (2012), which are all incorporated herein by reference.

In various approaches, after a block copolymer film has been applied to/deposited on a substrate, the entire sample (i.e., the substrate and the block copolymer film thereon) may be thermally or solvent annealed to induce microphase separation of the block copolymer film. Thermal annealing involves heating a sample (the substrate and block copolymer film) well above T_{g} (but below the order-disorder temperature ODT). This is the most common form of annealing for block copolymers. However thermal annealing has some limitations. For example, a polymer that decomposes above T_{g} cannot be thermally annealed. Second, if the polymer-air interface is not neutral to both blocks, it is not possible to obtain perpendicular orientation of the block copolymer domains with respect to the substrate without the use of complex top-coats. A third limitation is that some polymer films may dewet upon thermal annealing depending on thickness and interfacial energies.

The entire sample (the substrate and block copolymer fill) may also be solvent annealed, i.e., annealed in the presence of a controlled atmosphere containing solvent vapors. A solvent that is good for the block copolymer film (e.g., is good for all incompatible/immiscible polymer block components) may interact with the polymer, thereby swelling the chains and effectively depressing T_{g}. If enough solvent mass uptake occurs, then T_{g} may be depressed well below room temperature facilitating molecule diffusion towards the equilibrium state. Moreover, the use of a controlled atmosphere may allow the polymer-gas interfacial energy to be tuned, which may help promote perpendicular orientation of the block copolymer domains with respect to the substrate. Solvent annealing, however, also has some limitations. For instance, solvent annealing has been found to be prone to dewetting, especially where films are annealed over moderate to long time periods, typically in the time frame of a few hours. The developing rate of dewetting is a function of thickness and molecular weight of polymer thin film, and the interaction among solvent, polymer, and substrate surface. Higher swelling ratios are often desired to obtain defect-free self-assembled structures, but a higher swelling ratio may render unstable films that will likely dewet. Moreover, the maximum swelling ratio of the block copolymer film depends on the concentration of solvent molecules in the atmosphere, which in turn is limited by the vapor pressure of the solvent.

Embodiments disclosed herein describe an exemplary system and method for solvent annealing block copolymers in super-saturated atmospheres, which yields high swelling ratios, short annealing times, avoids or substantially reduces film dewetting and provides a compatible film-gas interface for perpendicularly oriented block copolymer domains.

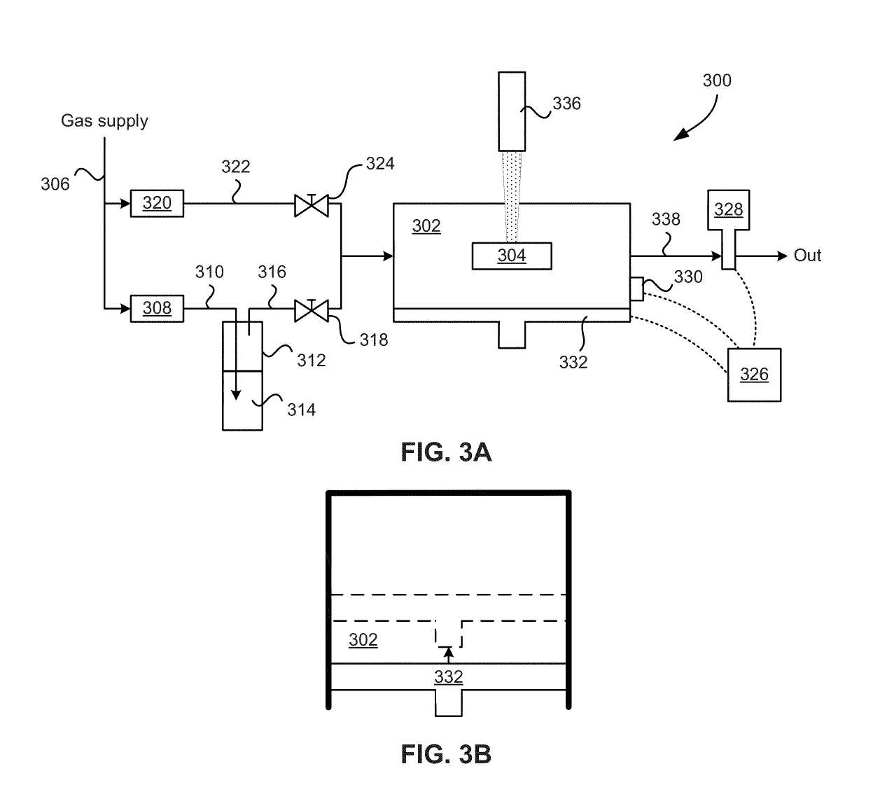

FIG. 3A depicts a system 300 for solvent annealing a block copolymer film in a super-saturated atmosphere, in accordance with one embodiment. As an option, the present system 300 may be implemented in conjunction with features from any other embodiment listed herein, such as those described with reference to the other FIGS. Of course, the system 300 and others presented herein may be used in various applications and/or in permutations which may or may not be specifically described in the illustrative embodiments listed herein. In some approaches, the system 300 may be a stand-alone system. In other approaches, the system 300 may be integrated into existing systems (e.g., an existing thin film manufacturing system).

As shown in FIG. 3A, the system 300 includes a solvent annealing chamber 302 with a sample 304 present therein. The sample 304 may include a substrate having a block copolymer film applied thereto. In some approaches, the substrate may include any suitable substrate material as would be understood by one having skill in the art upon reading the present disclosure. For example, substrates such as silicon or gallium arsenide may be used for semiconductor applications; substrates such as silicon, quartz, or glass may be used for patterned media applications, etc. In more approaches, a surface of the substrate may have at least one of a chemical and topographical contrast for directing/guiding the self-assembly of block copolymer domains.

As also shown in FIG. 3A, the system 300 includes a carrier gas supply line 306. This carrier gas supply line 306 provides N₂ gas or other suitable inert carrier gas as would be understood by one having ordinary skill in the art upon reading the present disclosure. While not so limited, the carrier gas supply line 306 shall be described herein for purposes of clarity and simplicity as providing N₂ gas.

The carrier gas supply line 306 is coupled to a first mass flow controller 308, which is coupled to a first carrier fine 310. In various approaches, the first mass flow controller 308 is configured to control the flow, and thus the amount, of N₂ gas present in the first carrier line 310. The first carrier line 310 is in fluidic communication with an interior of a source apparatus 312 for solvent vapor. Accordingly, after leaving the first mass flow controller 308, the N₂ gas travels via the first carrier line 310 and enters into the source apparatus 312 for solvent vapor. As used herein according to numerous approaches, the source apparatus 312 for solvent vapor may also be referred to as the “solvent vapor source apparatus”, or a “bubbler.”

The bubbler 312 contains a solvent 314. In some approaches, this solvent 314 may be a neutral solvent. A neutral solvent for a block copolymer film may be a solvent that has the same solvent-polymer interaction parameter with respect to the polymeric domains. As a result, interaction between an A-B diblock copolymer and a neutral solvent may result in the swelling of the A and B microdomains to nearly the same extent. In contrast, a selective solvent may preferentially swell one of the microdomains to a greater extent than the others. For instance, interaction between the same A-B diblock copolymer with an A-selective solvent may result in the A blocks being swollen to a greater extent (e.g., have more solvent mass uptake) relative to the B blocks. In a preferred approach, the solvent 314 may be acetone.

In more approaches, the bubbler 312 may contain more than one solvent. According to one particular approach, the bubbler 312 may contain two or more solvents that are each selective for one specific polymer block present in the block copolymer film. For instance, for an A-B diblock copolymer film, the bubbler 312 may contain an A-selective solvent and a B-selective solvent. However, in some approaches where two or more selective solvents are present, such selective solvents may have similar solvent-polymer interaction parameters. Stated another way, in such approaches where two or more selective solvents are present, each of the selective solvents may swell their respective polymer block to the same or substantially the same extent, such that the overall combination of the two or more selective solvents may be considered to nevertheless be neutral for the overall block copolymer film.

In other approaches, the system 300 may include two or more bubblers. This may be advantageous in approaches where two or more selective solvents may be used, each of the selective solvents being present in a different (e.g., physically separate) bubbler. For instance, in an approach where two selective solvents are to be used, one of the selective solvent may be present in one of the bubblers, while the other selective solvent may be present in the other bubbler.

With continued reference to FIG. 3A, the bubbler 312 may be configured to generate solvent vapor at or near saturation at a given temperature. Solvent vapor that is at or near saturation is solvent vapor that is at or within about 10% of the dew point. As used herein, the dew point refers to the temperature at which vapor in a given atmosphere condenses at the same rate at which it evaporates.

As also shown in FIG. 3A, the bubbler 312 is coupled to a second carrier line 316, which is in fluidic communication with an interior of the solvent annealing chamber 302. Accordingly, after leaving the bubbler 312, a gas mixture including the solvent vapor and carrier N₂ gas travels via the second carrier line 316 and enters into the solvent annealing chamber 302. A valve 318 may also interrupt the second carrier line 316 to allow, prevent and/or reduce the flow of the gas mixture therein.

As additionally shown in FIG. 3A, the gas supply line 306 is also coupled to a second mass flow controller 320, which is coupled to a dilution line 322. In various approaches, the second mass flow controller 320 is configured to control the flow, and thus the amount, of N₂ gas present in the dilution line 322. Moreover, in various approaches, the temperature of the dilution line 322, and thus the N₂ gas therein, may be kept at the same temperature as the saturated or near saturated atmosphere in the bubbler 312, and may be used to dilute the gas mixture leaving the bubbler 312, which includes the saturated or near saturated solvent vapor and N₂ carrier gas. A valve 324 may also interrupt the dilution line 322 to allow, prevent and/or reduce the flow of the N₂ gas therein.

In various approaches, the system 300 further includes a controller 326 that is configured to control at least one processing parameter for inducing a super-saturation of solvent vapor present within the atmosphere within the solvent annealing chamber 302. In various approaches, the at least one processing parameter may include a pressure in the solvent annealing chamber 302, a temperature in the solvent annealing chamber 302, volume in the solvent annealing chamber 302, a temperature in the bubbler 312, and a pressure in the bubbler 312. In various approaches, the controller 326 may be implemented in hardware and/or software, and may make use of a processor (not shown) for executing commands of a type known in the art, such as a central processing unit (CPU), a field programmable gate array (FPGA), an application specific integrated circuit (ASIC), etc.

The super-saturated solvent atmosphere may be achieved/induced either by a manual or automated way. For example, in some approaches, the controller 326 may be configured to select and/or control one or more processing parameters for inducing a super-saturated atmosphere within the solvent annealing chamber 302 according to a default algorithm. Such a default algorithm may include preferences for the manner in which the super-saturated atmosphere is induced, according to one particular approach. Far example, the processing parameters may be prioritized, such that production of the super-saturated atmosphere may be induced by controlling a processing parameter assigned the highest priority if possible, otherwise inducing the super-statured atmosphere by controlling the processing parameter with the next highest priority, and so on. In other approaches, the controller 326 may be configured to select and/or control these processing parameters based on the specific solvent present in the bubbler 312, the specific block copolymer present in the sample 304, the specific conditions associated with the system 300 prior to induction of the super-saturated atmosphere, etc. In more approaches, these processing parameters may be selected and/or controlled according to user preferences.

As shown in FIG. 3A, the controller 326 is in communication with a pressure control feature 328, a temperature control feature 330 and/or a volume control feature 332. In some approaches, the controller 326 may be in communication with one, some or all of the control features (e.g., 328, 330, 332) via a physical connection and/or via network (e.g., wide area network (WAN) such as the internet, a local area network (LAN), public switched telephone network (PSTN), internal telephone network, etc.). It is important to note that while only one controller 326 is shown in FIG. 3, the system 300 may include two or more controllers in additional approaches. In approaches where more than one controller may be present, each control feature (e.g., 328, 330, 332) may be coupled to different controllers. In such approaches, each of these independent controllers may be apart of/integral to the particular control feature with which it is in communication with, be located remotely from its respective control feature, etc. In other approaches where more than one controller may be present, two of the control features (e.g., 328 and 330, 328 and 332, or 330 and 332) may be coupled to the same controller while the remaining control features is coupled to a different controller, all of the control features 328, 330, 332) may nevertheless be coupled to the same controller, etc.

In some approaches, the control features described above may be additionally selected and/or controlled by a user. By way of example only, consider the case where the controller 326 is configured to control a specific control feature to induce a super-saturated atmosphere within the solvent annealing chamber 302. In some instances, that specific control feature may also be manually controlled/adjusted, e.g., by a user, in order to hasten induction of the super-saturated atmosphere, adjust the extent of super-saturation, etc. In other approaches where the controller 326 may be configured to automatically select and/or control a specific control feature (and thus a specific processing parameter) for inducing the super-saturated atmosphere within the solvent annealing chamber 302, a user may be able to override the controller's 326 automatic selection and/or control of the specific control feature and instead manually select and/or control a different control feature (and processing parameter) for inducing said super-saturated atmosphere.

The pressure control feature 328 illustrated in FIG. 3A may be configured to control/adjust/regulate a pressure of the atmosphere within the solvent annealing chamber 302, in various approaches. In one preferred approach, the pressure control feature 328 may be a pinhole valve.

The temperature control feature 330 may be configured to control/adjust/regulate a temperature of the atmosphere within the solvent annealing chamber 302, in more approaches. For example, in particular approaches this temperature control feature may be configured to heat (e.g., via a heater) and/or cool the atmosphere within the solvent annealing chamber 302.

The volume control feature 332 may be configured in control/adjust/regulate a volume of the atmosphere within the solvent annealing chamber, in additional approaches. In some approaches, this volume control feature 332 may include a piston, which may span the entire width of the solvent annealing chamber and which may be engaged to alter the volume therein. A simplified representation of the solvent annealing chamber 302 including a piston volume control feature 332 is shown in FIG. 3B, according to one illustrative approach.

With continued reference to FIG. 3A, the system 300 further includes a thickness monitoring device 336 coupled to the solvent annealing chamber 302. This thickness monitoring device 336 may be configured to monitor the thickness of the block copolymer film in the sample 304. In some approaches, the film thickness monitoring device 336 may be an optical reflectometer, an ellipsometer, or other such suitable device as would be understood by one having skill in the art upon reading the present disclosure.

As mentioned previously, solvent annealing involves exposing the sample 304 to solvent vapor present in the solvent annealing chamber 302. Exposure of the block copolymer film present in the sample 304 to the solvent vapor results in solvent mass uptake into the film, and thus a swelling of the polymer film. In general, there is a limit to this solvent intake, which may be described by the Flory-Huggins theory of polymer solutions described in detail below. However, solvent annealing in a super-saturated solvent vapor atmosphere as described in various embodiments herein, may allow more solvent intake than would otherwise be allowed in typical, saturated atmospheres. Accordingly, monitoring the thickness of the block copolymer film in the sample 304 may be helpful in monitoring the efficiency and effectiveness of the solvent annealing process within the solvent annealing chamber 302.

In order to describe saturation and/or super-saturation of solvent vapor within the solvent annealing chamber 302, reference is made to several processing parameters (e.g., pressure, volume, temperature, mole fraction of the solvent vapor, etc.) within solvent annealing chamber 302 and the bubbler 312. For simplicity, the following description assumes that the dilution line 322 is shut and all gas is brought to the chamber using the first and second carrier lines 310, 316. Moreover, it also assumed that only one solvent (solvent A) is present within the bubbler 312. In additional, all primed parameters correspond to parameters that are associated with (e.g., are occurring within an interior of) the solvent annealing chamber 302.

In view of the assumption detailed directly above, the partial pressures in the solvent annealing chamber 302 may be explained according to the following thermodynamic relations. For instance, inside the closed bubbler 312, the partial pressure of the solvent A (P_{A}) is given by Raoult's law:

P_{A}=x_{A}*P*_{A} Eq. (1)

where x_{A} denotes the solvent mole fraction of component A, and P*_{A} is the vapor pressure of pure component A. The solvent mole fraction of component A (x_{A}) may be assumed to be ˜1 given that the solvent A is the only solvent in the bubbler 312 and the mole fraction of N₂ gas is negligible compared to that of the solvent. Accordingly, the partial pressure of the solvent is nearly equal to its vapor pressure (P_{A}≈P*_{A}).

In some approaches the total pressure in the bubbler 312 may be kept at P_{T}=P_{G}+P_{A}, where P_{G} represents the partial pressure of the carrier gas. In such approaches, the conditions associated with the gas in the bubbler 312 and the solvent annealing chamber 302 may, according to the ideal gas law, be represented by the following two equations:

P_{T}V_{T}=n_{T}RT (bubbler) Eq. (2)

P′_{T}V′_{T}=n′_{T}RT′ (chamber) Eq. (3)

With regard to Equation (2), P_{T} denotes the absolute pressure of the gas in the bubbler 312, V_{T} denotes the volume of the gas in the bubbler, n_{T} denotes the number of moles of the gas in the bubbler, R denotes the ideal gas constant, and T denotes the absolute temperature of the gas in the bubbler. With regard to Equation (3), P′_{T} denotes the absolute pressure of the gas in the solvent annealing chamber 302, V′_{T} denotes the volume of gas in the chamber, n′_{T} denotes the number of moles of the gas in the chamber, and T′ denotes the absolute temperature of the gas in the chamber.

Again assuming that the dilution line 322 is shut such that there is no dilution of the gas mixture (the carrier gas and the solvent vapor) that travels via the second carrier line 316 to enter an interior of the solvent annealing chamber 302, and that there is a sufficiently low volumetric flow of carrier gas in the first and second carrier lines (310, 316), the mole fraction of solvent A (y_{A}) in the gas mixture may be given by:

$${y}_{A} = \frac{{P}_{A}}{{P}_{T}} = \frac{{n}_{A}}{{n}_{T}} = \frac{{P}_{A}^{′}}{{P}_{T}^{′}} = \frac{{n}_{A}^{′}}{{n}_{T}^{′}} . \qquad Eq . ( 4 )$$

Equations 1 to 4 may thus be used to find the partial pressure of solvent A (P′_{A}) within the solvent annealing chamber 302 for a given set of conditions. For example, saturation may be achieved in approaches where:

$$\frac{{P}_{A}}{{P}_{A}^{′}} \approx 1 \qquad Eq . ( 5 )$$

Moreover, super-saturation may be achieved in approaches here:

$$\frac{{P}_{A}^{′}}{{P}_{A}^{*}} > 1 \qquad Eq . ( 6 )$$

In some approaches, the solvent intake in the block copolymer film present in in the solvent annealing chamber 302 may be described by the Flory-Huggins theory of polymer solutions. According to this theory, solvent activity may be given by:

$$ln ( \frac{P}{{P}_{O}} ) = {χφ}_{p}^{2} - ln ( 1 - {φ}_{p} ) + {φ}_{p} ( 1 - \frac{1}{N} ) \qquad Eq . ( 7 )$$

where φₚ denotes the volume fraction of the polymer in solution, P denotes the partial pressure of the solvent, P_{O} denotes the vapor pressure of the solvent, N denotes the degree of polymerization and χ denotes the solvent-polymer interaction parameter. The volume fraction of the polymer in solution (φₚ) may be given by:

$${φ}_{p} = \frac{1}{( 1 + SR )} \qquad Eq . ( 8 )$$

where SR is the swelling ratio. The swelling ratio (SR) may be further represented by:

$$SR = \frac{( V - {V}_{O} )}{{V}_{O}} = \frac{( h - {h}_{O} )}{{h}_{O}} \qquad Eq . ( 9 )$$

where V denotes the initial volume of the polymer film, V_{O} denotes the final volume of the polymer film (e.g., at its swollen state), h denotes the initial thickness of the polymer film, and h_{O} denotes the final thickness of the polymer film (e.g., at its swollen state). It is important to note that the Flory-Huggins model represented in Equation (7) describes a system in thermodynamic equilibrium. Moreover, it is also important to note that the solvent-polymer interaction parameter, χ, is often a function of polymer volume fraction in the mixture/solution and may be generally expressed as:

$$χ ( φ , T ) = a + \frac{b}{T} + ( c * φ ) + ( d * {φ}^{2} ) \qquad Eq . ( 10 )$$

In approaches where the solvent is acetone, the solvent-interaction parameter, χ, decreases with more solvent uptake (however not all solvents behave like this).

According to Equation 7, a higher solvent activity (P/P_{O}) generally corresponds to a lower polymer volume fraction (φₚ) and hence a higher swelling ratio (SR). Thus, depending on the particular dependence of χ with φₚ, at a given temperature the highest possible swelling ratio at equilibrium may be obtained as the activity approaches

$$1 ( \frac{P}{{P}_{O}} \approx 1 ) .$$

According to various approaches, there may be cases in the solvent annealing of block copolymers for directed self-assembly where a higher solvent intake (and hence a higher swelling ratio) may be needed to achieve defect-free assembly. Therefore, in such cases, the solvent activity may need to be brought above

$$1 ( \frac{P}{{P}_{O}} > 1 )$$

for a higher solvent intake. The embodiments disclosed herein which achieve super-saturated atmospheres achieves this goal. A super-saturation condition is no longer at equilibrium, thus the Flory-Huggins theory of polymer solutions described in Equation (7) may not accurately reflect the solvent intake. However, the solvent intake in super-saturated conditions may nevertheless be estimated based on the swelling ratio in such approaches. This swelling ratio may be measured in various approaches via the film thickness device 336 shown in FIG. 3.

According to one particular embodiment, the controller 326 may be configured to induce a super-saturation of the solvent vapor in the atmosphere within the solvent annealing chamber 302 by increasing the pressure within the solvent annealing chamber 302. This particular embodiment may also involve maintaining a constant temperature within the solvent annealing chamber 302 and a constant mole fraction of the solvent vapor within the second carrier line 316. For instance, the system 300 may be brought to equilibrium under saturated solvent vapor at temperature Tₛ, where Tₛ is the temperature in the bubbler 312 and inside the solvent annealing chamber 302. The system 300 may be brought to equilibrium by flowing the inert gas (e.g., N₂) through the bubbler 312 with a flow f₁ in sccm (5˜500 sccm), in one approach. Provided the flow is low enough that the saturation condition is sustained, the gas (i.e., the solvent vapor and carrier gas) in the solvent annealing chamber 302 may remain close to saturation with P_{A}≈P*_{A} according to Equation 1. This particular saturated condition may be referred to as the initial condition of the system 300 according to this particular embodiment. It is important to note, however, that a different initial condition may be chosen without loss of generality.

After achieving the initial saturated condition described directly above, the absolute mole content, n′_{A} of the solvent vapor in the solvent annealing chamber 302 may be momentarily increased by increasing the pressure (P′_{T}) in the solvent annealing chamber 302 at a constant temperature without modifying the mole fraction of solvent A (y_{A}) in the second carrier line 316. This may be accomplished in some approaches by restricting the outlet line 338 from the solvent annealing chamber 302 using the pressure control feature 328 (e.g., a pinhole valve), and/or by increasing the flow of the carrier gas in the first and second carrier lines 310, 316. The restricted flow may generate a transient condition where there is both an increase in the absolute pressure (P′_{T}) and the partial pressure of solvent A (P′_{A}) in the solvent annealing chamber 302. Since P_{A}≈P*_{A} and P′_{A}>P_{A}, it follows that that

$$\frac{{P}_{A}^{′}}{{P}_{A}^{*}} > 1.$$

Accordingly, a super-saturation condition will occur for a short period of time while the excess solvent vapor condenses and a new equilibrium is reached. During this transient condition, the block copolymer film in the sample 304 may swell at a higher ratio than is otherwise possible during the initial saturated condition described above. Therefore, as evidenced by this particular embodiment, a controlled

$$\frac{{P}_{A}^{′}}{{P}_{A}^{*}}$$

ratio and a sufficiently short transient condition (e.g., preferably less than about 2 minutes) may result in a high swelling ratio without film dewetting.

According to another specific embodiment, the controller 326 may be configured to induce a super-saturation of the solvent vapor in the atmosphere within the solvent annealing chamber 302 by lowering the temperature of the atmosphere within the solvent annealing chamber 302. This specific embodiment may also involve maintaining a constant pressure within the solvent annealing chamber 302 and a constant mole fraction of the solvent vapor within the second carrier line 316. For instance, the system 300 may be brought to equilibrium under saturated vapor at temperature Tₛ, where Tₛ is the temperature in the bubbler 312 and inside the solvent annealing chamber 302. This may be accomplished in various approaches by flowing the carrier gas through the bubbler 312 with a flow f₁ sccm (5˜500 sccm). Provided the flow is low enough that the saturation condition is sustained, the gas (i.e., the solvent vapor and carrier gas) in the solvent annealing chamber 302 may remain close to saturation with P_{A}≈P*_{A} according to Equation 1. Again, this particular saturated condition may be referred to as the initial condition of the system 300 according to this specific embodiment. However, a different initial condition could be chosen without loss of generality.

After achieving the initial saturated condition described directly above, a super-saturation condition may be achieved by cooling the solvent annealing chamber 302 to a temperature T′ such that T′<Tₛ. This change in temperature lowers the vapor pressure of the solvent (P*_{A}′) within the solvent annealing chamber 302 relative to the vapor pressure of the solvent (P*_{A}) within the bubbler 312 (P*′_{A}<P*_{A}). Since P′_{A}=P_{A}≈P*_{A} and P*_{A}′<P*_{A}, it follows that that

$$\frac{{P}_{A}^{′}}{{P}_{A}^{* ′}} > 1.$$

Accordingly, a super-saturation condition may occur with a consequent condensation. By towering the temperature of the atmosphere within the solvent annealing chamber 302 as described in the specific embodiment above, the system 300 may reach steady state condition in which a steady condensation occurs until the temperature in the solvent annealing chamber 302 is raised again or the flow is diluted. Achieving this steady state super-saturation condition by lowering the temperature within the solvent annealing chamber 302 (e.g., at constant pressure and solvent mole fraction in the second carrier line 316) is thus different than achieving a transient super-saturated condition by increasing the pressure within the solvent annealing chamber 302 (e.g., at constant temperature and solvent mole fraction in the second carrier line 316).

According to yet another exemplary embodiment, the controller 326 may be configured to induce a super-saturation of the solvent vapor in the atmosphere within the solvent annealing chamber 302 by reducing the volume of the atmosphere within the solvent annealing chamber 302. This exemplary embodiment may also involve maintaining a constant temperature and a constant mole fraction of the solvent vapor within the second carrier line 316. For instance, the system may be brought into equilibrium under saturated vapor at temperature Tₛ, where Tₛ is the temperature in the bubbler 312 and inside the solvent annealing chamber 302. This may be accomplished in various approaches by flowing the carrier gas through the bubbler 312 with a flow f₁ in sccm (5˜500 sccm). Provided the flow is low enough that the saturation condition is sustained, the gas (i.e., the solvent vapor and carrier gas) in the solvent annealing chamber 302 may remain close to saturation with P_{A}_{≈P*}_{A} according to Equation 1. Again, this particular saturated condition may be referred to as the initial condition of the system 300 according to this exemplary embodiment. However, a different initial condition could be chosen without loss of generality.

After achieving the initial saturated condition described directly above, a super-saturation condition may be achieved by first closing the solvent annealing chamber's 302 inlet ports valves 318, 324) and outlet ports (e.g., pressure control feature 328) such that no gas enters or leaves the solvent annealing chamber 302, and subsequently reducing the volume of the atmosphere therein. In one particular approach, the body of the solvent annealing chamber 302 may be constructed as a piston (e.g., as shown in FIG. 3B) such that the volume (V′) within the solvent annealing chamber 302 may be changed by sliding the piston up or down at least one of the chamber's sides without leaks (e.g., no gas escapes around the edges of the piston that contact the chamber). In preferred approaches, this volume change may be performed slowly enough so as to keep a constant temperature within the solvent annealing chamber 302.

Continuing with the above exemplary embodiment, in approaches where the volume in the solvent annealing chamber 302 is reduced from V′₁ to V′₂ such that V′₂<V′₁, the partial vapor pressure of solvent A (P′_{A}) in the solvent annealing chamber 302 may change to

$${P}_{A}^{′} = {P}_{A} * ( \frac{{V}_{1}^{′}}{{V}_{2}^{′}} ) .$$

### Since

$${P}_{A} \approx {P}_{A}^{*} and \frac{{V}_{1}^{′}}{{V}_{2}^{′}} > 1 ,$$

it follows that

$$\frac{{P}_{A}^{′}}{{P}_{A}^{*}} > 1.$$

Accordingly, a super-saturated condition may occur with a consequent transient condensation. In this exemplary embodiment, similar to achieving a super-saturated condition by increasing the pressure within the solvent annealing chamber 302 (e.g., at constant temperature and solvent mole fraction in the second carrier line 316), the condensation is a transient state that may occur over a short period of time while the system reaches equilibrium at the new pressure. This transient state may thus cause the solvent annealed film to swell at a larger ratio than would otherwise be possible under regular solvent annealing, according to this exemplary embodiment.

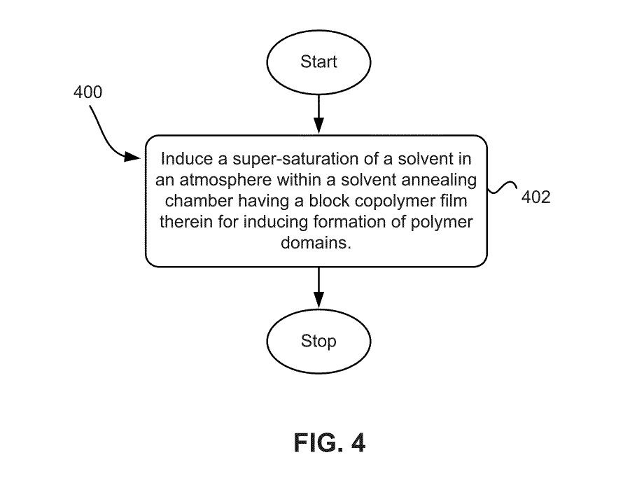

Now referring to FIG. 4, a method 400 for solvent annealing a block copolymer film under a super-saturated atmosphere is shown, in accordance with one embodiment. As an option, the method 400 may be implemented to form solvent-annealed block copolymer films such as those described in other figures. Of course, this method 400 and others presented herein may be used to form solvent-annealed block copolymer films for a wide variety of devices and/or purposes which may or may not be related to magnetic recording. In preferred approaches, the method 400 may be carried out in a solvent annealing chamber, such as that described in FIG. 3A.

As shown in FIG. 4, the method includes inducing a super-saturation of a solvent in an atmosphere within a solvent annealing chamber having a block copolymer film therein for inducing formation of polymeric domains. See, operation 402. In preferred approaches, the solvent is a neutral solvent, such as acetone.

In some embodiments, the method 400 may further include generating solvent vapor at or near saturation in a solvent source apparatus e.g., a bubbler). According to various approaches, solvent vapor that is at or near saturation may correspond to solvent vapor having a temperature equal to or within (but not above) about 10% of the dew point. The method 400 may also cause the saturated or nearly saturated solvent vapor to enter the solvent annealing chamber, e.g., with the aid of an inert carrier gas traveling through a carrier line in fluidic communication with an interior of the solvent vapor source apparatus and an interior of the solvent annealing chamber.

In one embodiment the super-saturation of the solvent in the atmosphere within the solvent annealing chamber may be induced by increasing a pressure within the solvent annealing chamber. In preferred approaches, the increase in the pressure within the solvent annealing chamber may occur at about a constant temperature in the solvent annealing chamber and at about a constant mole fraction of the solvent vapor in the aforementioned carrier line.

In another embodiment, the super-saturation of the solvent in the atmosphere within the solvent annealing chamber may be induced by lowering a temperature of the atmosphere within the solvent annealing chamber, e.g., by towering a temperature of the atmosphere within the solvent annealing chamber relative to a temperature of the atmosphere within the source apparatus. In preferred approaches, the lowering of the temperature may occur at about a constant pressure within the solvent annealing chamber and at about a constant mole fraction of the solvent vapor in the aforementioned carrier line.

In yet another embodiment, the super-saturation of the solvent in the atmosphere within the solvent annealing chamber may be induced by reducing a volume of the atmosphere within the solvent annealing chamber while maintaining a constant molar mass of gas therein. In preferred approaches, the reducing of the volume may occur at about a constant temperature in the solvent annealing chamber and at about a constant mole fraction of the solvent vapor in the aforementioned carrier line.

In further embodiments, the method 400 may also include reversing the super-saturation of the solvent in the atmosphere within the solvent annealing chamber within less than 2 minutes after inducing the super-saturation of the solvent. Solvent annealing in a super-saturated atmosphere may lead to larger swelling ratios (e.g., larger solvent mass uptake) than would otherwise be possible in conventional solvent annealing processes under saturated or near-saturated atmospheres. Moreover, achieving these larger swelling ratios in such short time periods (e.g., less than 2 minutes) may prevent dewetting of the block copolymer film.

In additional embodiments, prior to inducing the super-saturation condition, the method 400 may include depositing/forming a block copolymer film on a substrate and/or placing the block copolymer film/substrate sample within a solvent annealing chamber (not shown in FIG. 4). In some approaches, this substrate may have at least one of a chemical and a topographical contrast for inducing directed self-assembly upon the solvent annealing. Patterns on the substrate may also be formed via optical, electrical, mechanical patterning and other such methods of selectively activating a substrate as would be understood by one having ordinary skill in the art upon reading the present disclosure.

In more embodiments prior to inducing the super-saturation condition, the method 400 may include providing a block copolymer film already formed/deposited on a substrate, and/or placing the block copolymer film/substrate sample within a solvent annealing chamber.

In yet more embodiments, the method 400 may induce formation of lamellar microdomains in the block copolymer film, where such microdomains have a pitch less than or equal to about 20 nm, preferably less than about 15 nm. As used herein, the pitch may refer to the center-to-center spacing between the nanofeatures (e.g., the lamellae).

In still more embodiments, the method 400 may include selective y removing one of the block copolymer components. In some approaches, the pattern of perpendicularly-oriented block copolymer components may be used to form an etch mask for patterning nanosized features into the underlying substrate via selective removal of one of the self-assembled polymer blocks.

### EXAMPLE

The following non-limiting example provides one embodiment of solvent annealing a triblock copolymer film in a solvent annealing chamber under super-saturation of solvent vapor therein. It is important to note that the following example is for illustrative purposes only and does not limit the invention in anyway. It should also be understood that variations and modifications of this examples may be made by those skilled in the art without departing from the spirit and scope of the invention.

A thin film of a triblock copolymer of poly(2 vinyl pyridine-b-styrene-b-2 vinyl pyridine) with molecular weight of 8-16-8 Kg/mol was deposited on a substrate with neutral brush grafted on top. The film was placed in a solvent annealing chamber (e.g., similar to the chamber shown in FIG. 3A). A carrier gas line supplied N₂ gas to a bubbler containing acetone. The carrier line was also in fluidic communication with an interior of the solvent annealing chamber such that the gas mixture leaving the bubbler (i.e., the carrier gas and acetone vapor) traveled via the carrier line into the interior of the chamber. The partial pressure of the solvent in the bubbler was approximately equal to the vapor pressure of acetone (P_{acetone}≈P*_{acetone}, Eq. (1)). The system was brought to an initial saturated, equilibrium condition

$$( \frac{{P}_{acetone}^{′}}{{P}_{acetone}^{*}} \approx 1 )$$

by flowing the N₂ gas through the bubbler with a flow rate of 50 sccm.

After the film reached an initial swelling ratio of 40% under the initial saturated condition, the absolute mole content of the acetone vapor, n′_{acetone}, in the solvent annealing chamber was momentarily increased by increasing the pressure (P′_{T}) in the solvent annealing chamber at a constant temperature and without modifying the mole fraction of the acetone, y_{acetone}, in the carrier line. For an annealing chamber with a volume of 2.7 cubic inch, this was accomplished by increasing the flow rate of the N₂ carrier gas in the carrier from 50 sccm to 100 sccm. The transient increase in pressure caused

$$\frac{{P}_{acetone}^{′}}{{P}_{acetone}^{*}} > 1$$

with a consequent condensation producing a large, and short-lived (e.g., about 1 minute) swelling ratio of 70%.

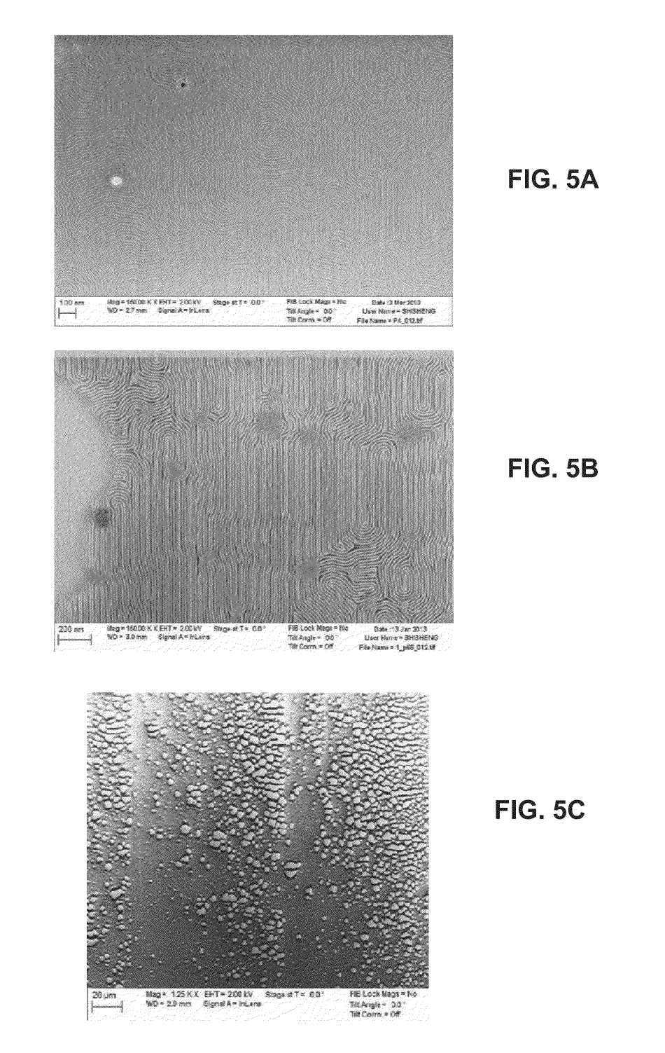

FIG. 5A illustrates a top-view of the P2VP-PS-P2VP triblock thin-film sample exposed to conventional solvent annealing below super-saturation. The triblock film shown in FIG. 5A was deposited on top of a chemical contrast pattern for directed self-assembly in order to facilitate the formation of patterns of parallel lines that were generally defect free. Due to the limited solvent intake associated with this solvent annealing process below super-saturation, annealing the film for a short period of time (<30 min) only generated partial guiding of the film's self-assembly in the vertical direction, resulting in a pattern with a large number of defects. While annealing the sample for longer times (several hours) under the same atmospheric conditions yielded a somewhat better assembly with a lower defect density, defects were still present as shown in FIG. 5B. Additionally, annealing the sample for longer times (several hours) under the same atmospheric conditions also resulted in the swollen film becoming unstable, leading to film dewetting as shown in FIG. 5C.

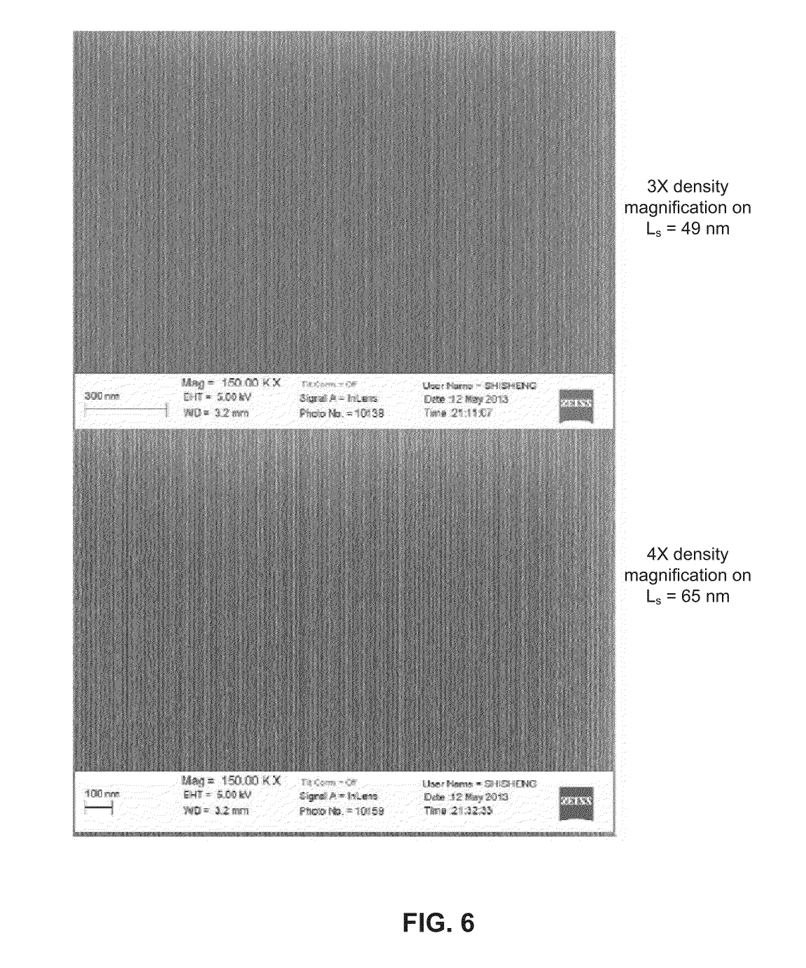

In contrast, FIG. 6 illustrates a top-view of the P2VP-PS-P2VP triblock thin-film sample exposed to solvent annealing under super-saturation of the neutral solvent vapor. The enhanced solvent intake facilitates a nearly defect free and faster self-assembly (e.g., within ˜1 mm). As shown in FIG. 6, the alternating lamellae are oriented parallel or substantially parallel with respect to each other. In other words, the top-view of the P2VP-PS-P2VP triblock thin-film shows straight or substantially straight rows/channels of alternating lamellae extending in the same direction along the substrate. Moreover each of the alternating lamellae are oriented perpendicular or substantially perpendicular to the substrate, which is not visible in the top-view of FIG. 6.

As evidenced by the comparison between FIGS. 5A-C and 6, the advantages of annealing in supersaturated atmosphere are twofold: (1) it is easier to prevent dewetting while achieving large swelling ratios due to the short time of the high swelling condition; and (2) the corresponding depression in the glass transition temperature and the reduction in interaction parameter between the polymer blocks enhances the polymer mobility, thus facilitating a faster assembly with a reduced defectivity.

Uses

The systems, apparatuses, and methods disclosed herein provide a process for solvent annealing block copolymer films in atmospheres containing super-saturated solvent vapor. As discussed in various embodiments, solvent annealing block copolymer films in atmospheres containing super-saturated solvent vapor achieves high swelling ratios over short time periods (e.g., less than 2 minutes), provides compatible film-gas interface for perpendicularly oriented block copolymer domains, and yet does not induce film dewetting. Moreover, solvent annealing block copolymer films in super-saturated atmospheres provides ordered block copolymer domains on a nanometer scale that can be prepared more quickly and with significantly less defects as compared to conventional solvent annealing in saturated or near-saturated atmospheres, thermal annealing, electron beam lithography, photolithography, etc. Further, solvent annealing block copolymer films in super-saturated atmospheres results in features with a pitch below about 20 nm, a feature size not able to be produced via the conventional techniques described above.

Illustrative, non-limiting uses/application of the embodiments disclosed herein include nanolithography for semiconductor devices; nanoimprint lithography for patterned magnetic recording media; fabrication of cell based arrays, photovoltaic cells, etc.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A system for solvent annealing of a block copolymer film, the system comprising:
a solvent annealing chamber; and
a controller configured to control at least one processing parameter for inducing a super-saturation of a solvent in an atmosphere within the solvent annealing chamber.

2. The system as recited in claim 1, further comprising a pressure control feature in communication with the controller for controlling a pressure of the atmosphere within the solvent annealing chamber.

3. The system as recited in claim 1, further comprising a temperature control feature in communication with the controller for adjusting a temperature of the atmosphere within the solvent annealing chamber.

4. The system as recited in claim 1, wherein the solvent annealing chamber includes a volume control feature in communication with the controller for adjusting a volume of the atmosphere within the solvent annealing chamber.

5. The system as recited in claim 1, further comprising a carrier line coupled to a source apparatus that is configured to generate solvent vapor at or near saturation, the carrier line being in fluidic communication with an interior of the solvent annealing chamber.

6. The system as recited in claim 5, wherein the controller is configured to induce the super-saturation of the solvent in the atmosphere within the solvent annealing chamber by lowering a temperature of the atmosphere within the solvent annealing chamber relative to a temperature of the atmosphere within the source apparatus.

7. The system as recited in claim 1, wherein the controller is configured to induce the super-saturation of the solvent in the atmosphere within the solvent annealing chamber by increasing a pressure within the solvent annealing chamber.

8. The system as recited in claim 1, wherein the controller is configured to induce the super-saturation of the solvent in the atmosphere within the solvent annealing chamber by reducing a volume of the atmosphere within the solvent annealing chamber while maintaining a constant molar mass of gas therein.

9. The system as recited in claim 1, wherein the controller is configured to reverse the super-saturation of the solvent in the atmosphere within the solvent annealing chamber within less than 2 minutes after inducing the super-saturation of the solvent.

10. The system as recited in claim 1, further comprising a thickness monitoring device configured to monitor a film thickness of a block copolymer film in the solvent annealing chamber.

11. A method for solvent annealing of a block copolymer film, the method comprising:
inducing a super-saturation of a solvent in an atmosphere within a solvent annealing chamber having a block copolymer film therein for inducing formation of polymeric domains.

12. The method as recited in claim 11, further comprising generating solvent vapor at or near saturation in a source apparatus, and causing the solvent vapor to enter an interior of the solvent annealing chamber.

13. The method as recited in claim 12, wherein the super-saturation of the solvent in the atmosphere within the solvent annealing chamber is induced by lowering a temperature of the atmosphere within the solvent annealing chamber relative to a temperature of the atmosphere within the source apparatus.

14. The method as recited in claim 11, wherein the super-saturation of the solvent in the atmosphere within the solvent annealing chamber is induced by increasing a pressure within the solvent annealing chamber.

15. The method as recited in claim 11, wherein the super-saturation of the solvent in the atmosphere within the solvent annealing chamber is induced by reducing a volume of the atmosphere within the solvent annealing chamber while maintaining a constant molar mass of gas therein.

16. The method as recited in claim 11, further comprising reversing the super-saturation of the solvent in the atmosphere within the solvent annealing chamber within less than 2 minutes after inducing the super-saturation of the solvent.

17. The method as recited in claim 11, further comprising monitoring a film thickness of a block copolymer film in the solvent annealing chamber.

18. The method as recited in claim 11, wherein the solvent is about neutral.

19. The method as recited in claim 11, wherein the block copolymer is poly(2 vinyl pyridine-b-styrene-b-2 vinyl pyridine) (P2VP-b-PS-b-P2VP), and the solvent includes acetone.

20. The method as recited in claim 11, wherein the block copolymer film is formed on a substrate having at least one of a chemical and a topographical contrast for inducing directed self-assembly upon the solvent annealing.
